(19) United States
(12) Patent Application Publication
(10) Pub. No.: US 2026/0045700 A1
(43) Pub. Date: Feb. 12, 2026

(54) Feed Assembly for Broadband GRIN Lens Multibeam Antenna

(71) Applicant: Southwest Research Institute, San Antonio, TX (US)

(72) Inventor: Stephen Andrew Long, Boerne, TX (US)

(21) Appl. No.: 19/297,684

(22) Filed: Aug. 12, 2025

Related U.S. Application Data
(60) Provisional application No. 63/682,313, filed on Aug. 12, 2024.

(51) Int. Cl. H01Q 15/06

(52) U.S. Cl. CPC H01Q 15/06

(57) ABSTRACT

A feed assembly for a multibeam antenna having a GRIN lens. A feed plate is attached to the GRIN lens and has a port for each channel of the antenna. A waveguide is associated with each port, each waveguide having an opening for transmitting a signal into the GRIN lens. A plug associated with each waveguide and made from the same material as the lens, is configured at a port end to fit into a port and configured at a waveguide end to fit into the associated waveguide.

### PRIORITY TO RELATED APPLICATION

This application claims the benefit of the filing date of U.S. App. No. 63/682,313, filed Aug. 12, 2024.

### BACKGROUND OF THE INVENTION

Gradient-index (GRIN) optics is characterized by optical effects produced by a gradient of the refractive index of a material. Such gradual variation can be used to produce lenses with flat surfaces, or lenses that do not have the aberrations typical of traditional spherical lenses. GRIN lenses may have a refraction gradient that is spherical, axial, or radial.

GRIN lenses have radio frequency (RF) applications, such as for multibeam antennas. Placing small antennas around a GRIN lens such as a Luneburg lens results in a multibeam antenna assembly. Signals going into or coming out of each antenna represent a “beam” in a different direction.

A multibeam antenna provides a fixed number of channels (beams), with each channel directing the RF signal to a different, but fixed, direction. Beams can be toggled simply by switching the antenna port for signal transmission/collection.

Waveguides are commonly employed as the primary feeding mechanism for multibeam antennas, channeling an RF signal to radiating elements. Waveguides play a crucial role in the design and operation of multibeam antennas, particularly in directing and shaping the electromagnetic radiation to create multiple, focused beams.

The conventional approach for feed antennas uses open-ended rectangular waveguides, typically commercial off-the-shelf (COTS) coax-to-waveguide adaptors. The majority are either WR42 or WR34 sizes. These standard rectangular apertures have fundamental operating ranges of 18-26.5 GHz and 22-33 GHZ, respectively. Hence the 1.5:1 ratio of operating bandwidth.

One problem with conventional open-ended waveguides is that their bandwidths fall short of what is required for systems that require an extremely wide bandwidth. For example, a common specification for warfare and intelligence support components is 2-18 GHz, a ratio of 9:1.

Another problem with conventional open-ended waveguides occurs when a GRIN lens undergoes transformational optics such as being made with a flat surface on one side. An open-ended waveguide placed on this flat side experiences high amounts of reflected power because of the abrupt interface between the low index air inside the waveguide and the high index dielectric at the boundary. The penalty can be seen in aperture efficiencies as well, which are low.

### BRIEF DESCRIPTION OF DRAWINGS

FIG. 1 illustrates how RF feed antennas may be placed around a GRIN lens to focus beams in different directions, resulting in a multibeam antenna.

FIG. 2 illustrates an example of a GRIN lens multibeam antenna.

FIG. 3 schematically illustrates feed ports (recesses) on the flat base of a GRIN lens.

FIG. 4 illustrates a feed plate having feed apertures corresponding to the feed ports of FIG. 3.

FIG. 5 illustrates a waveguide as a “front” view of a conventional WRD350 opening.

FIG. 6 illustrates a waveguide with a tapered transition from the waveguide opening.

FIG. 7 illustrates a plug that provides a keyed fit between the waveguide and a recessed port of the GRIN lens.

FIG. 8 is a side view of one example of a plug.

### DETAILED DESCRIPTION OF THE INVENTION

The following description is directed to a feeding scheme for a GRIN lens multibeam antenna. The feeding scheme allows RF signals to be directed across an extremely wide bandwidth.

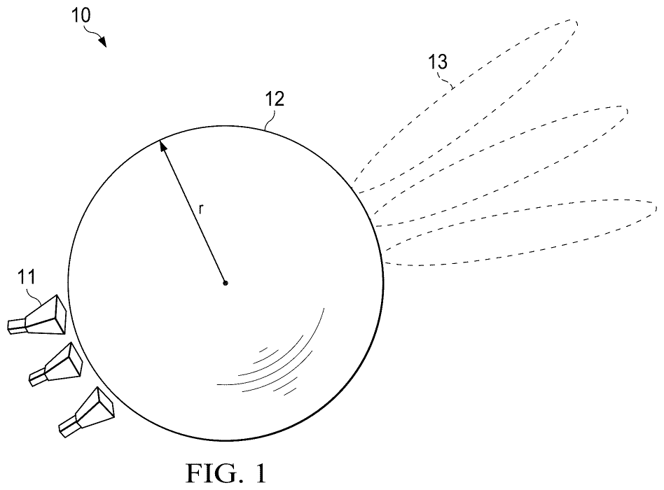

FIG. 1 illustrates a multibeam antenna 10, having RF feed antennas 11 placed around a GRIN lens 12 to focus beams 13 in different directions. For purposes of example, the GRIN lens 12 is a classic profile known as the Luneburg lens, which focuses rays onto a point on the opposite side. Placing small feed antennas 11 on these focal points results in a multi-beam aperture, where every input port represents a high gain beam in a different direction.

The GRIN lens multibeam antenna 10 of FIG. 1 has a spherical GRIN lens 12, but the feed scheme to which this description is directed is particularly useful for GRIN lenses having a flat interface. GRIN lenses may be manufactured using additive manufacturing techniques.

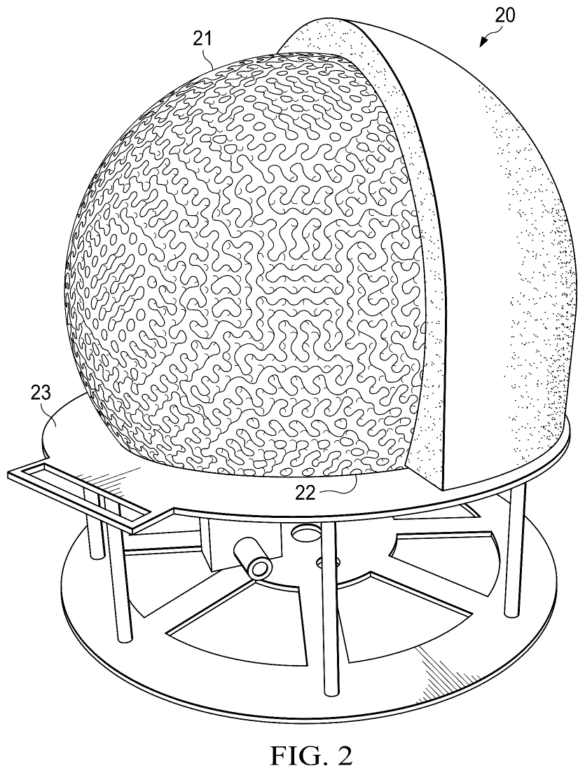

FIG. 2 illustrates an example of a GRIN lens multibeam antenna 20 with which the feed assembly described herein may be used. Antenna 20 comprises a spherical lens 21, having a flat base 22 for feed points. Lens 21 has a lattice structure, which involves arranging multiple GRIN lenses in a specific pattern. The term “lattice” refers to the lattice-based design used in the manufacturing of these lenses, particularly with 3D printing, to create the necessary dielectric gradient and achieve desired performance.

A feed plate 23 provides an interface with feed ports for attaching waveguides. Feed plate 23 is a flat plate, corresponding to the flat backside of lens 21. The feed ports and waveguides are not explicitly shown in FIG. 2 but are discussed below.

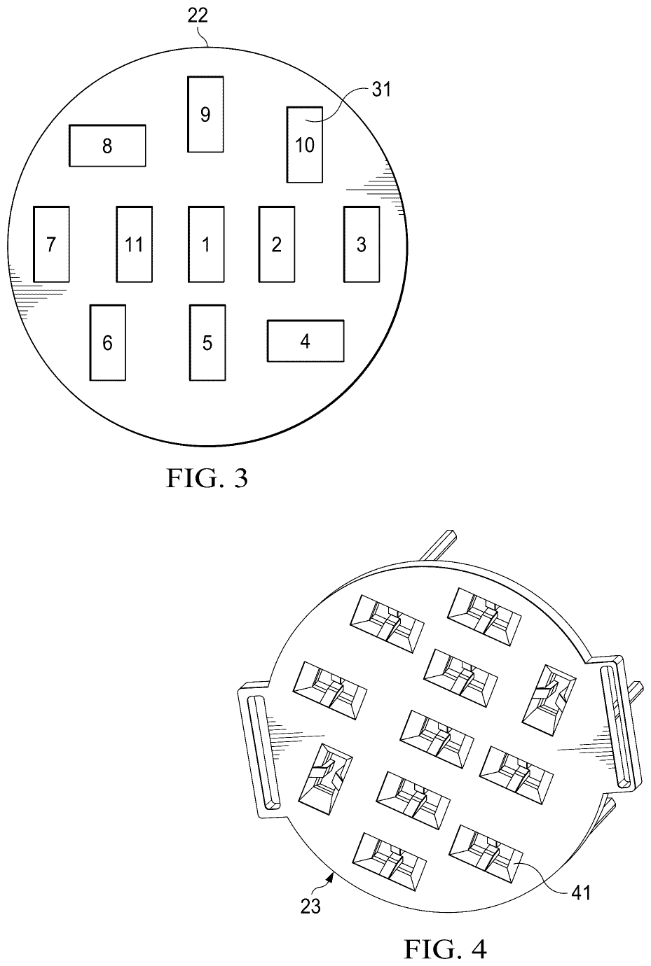

FIG. 3 schematically illustrates feed ports 31, which are recesses into the underside of the flat base 22 of lens 21. In the example of this description, lens 21 has 11 ports on its backside.

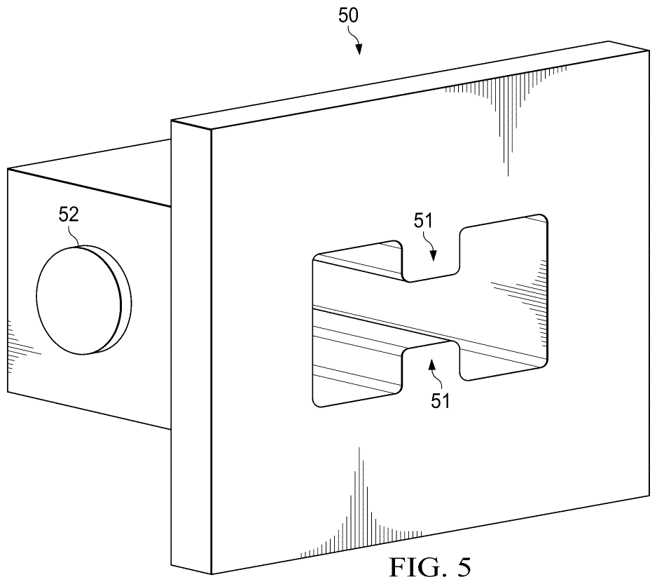

FIG. 4 illustrates a feed plate 23 having feed apertures 41 corresponding to the 11 ports of FIG. 3. Feed plate 23 is attached to the flat backside of lens 21. As explained below, each aperture 41 is an opening for inserting a plug, which then inserts into a waveguide aperture beneath the feed plate 23.

FIG. 5 illustrates a conventional waveguide 50 as a “front” view, here a WRD350 adapter opening. Waveguide 50 may be used to feed one port of antenna 10 by acting as a transmission line that delivers electromagnetic energy to the antenna. Waveguide 50 illuminates lens 21 and is excited via a coax-to-waveguide connection 52 with the coax (cable) carrying an excitation signal.

The conventional WRD350 opening provides a double-ridged rectangular waveguide aperture. The addition of the ridges 51 allows waveguide 50 to support a lower frequency than a rectangular opening equivalent. As adapters, these devices have industry standard sizes. For example, WRD350 adaptors have a standard rating of 3.5-8.2 GHZ, a bandwidth ratio of 2.3. However, while a double-ridged cross section supports broadband applications as a waveguide, it operates poorly as an open-ended waveguide antenna. The aperture's area is small which results in higher return loss than is acceptable.

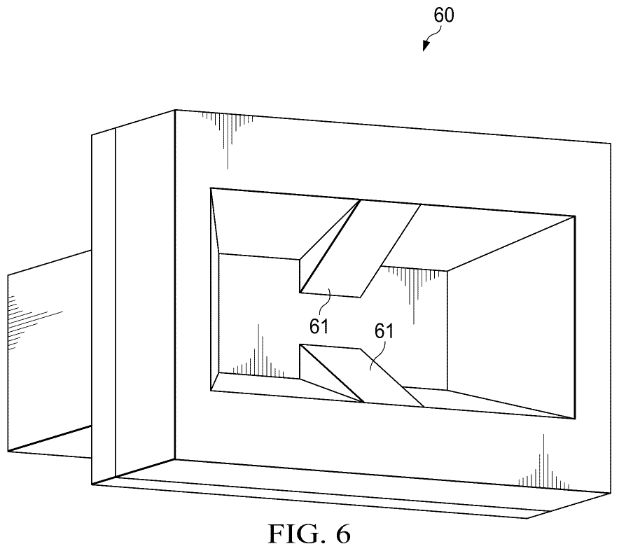

FIG. 6 illustrates a modified waveguide 60 and how applying a tapered transition from a double-ridged cross section transforms the waveguide opening into a nominal rectangular shape. This tapered transition is implemented with wedges 61 in the opening, in place of the rectangular ridges 51 of FIG. 5. This tapering corrects the return loss problem. The end result resembles a miniaturized double-ridged horn antenna.

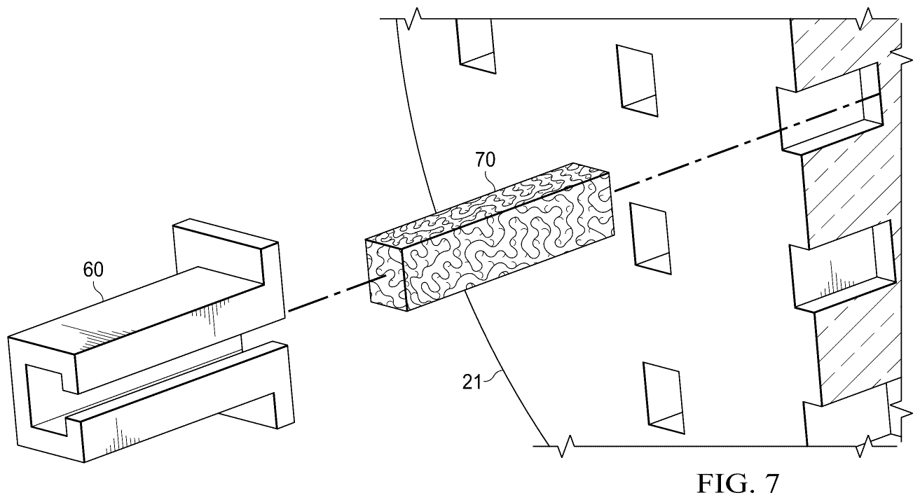

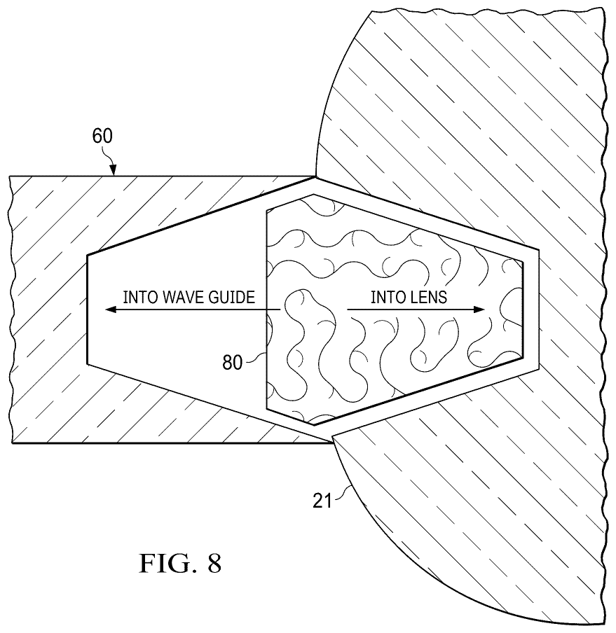

FIG. 7 is a representative illustration of how a plug 70 provides a keyed fit between the waveguide 60 and a recessed port of lens 21. Plug 70 is made out of the same material as the lens 21 and continues the lattice structure.

In the simplified example of FIG. 7, plug 70 is represented as having a rectangular tube configuration. However, in practice, various geometries may be used to provide both a keyed fit and desired transmission properties. In particular, wedged geometries may minimize losses and improve desired radiation patterns.

FIG. 8 is a side view of a plug 80 configured for waveguide 60. Here, plug 80 has tapering at each end. This tapering mitigates discontinuity between the air-filled waveguide 60 and the dielectric filled regions of lens 21. On the waveguide end of plug 80, the tapering may accommodate the tapering of the opening of waveguide 60 for a snug “keyed” fit. In other words, the waveguide end of plug 80 is shaped to fit into the shape of the waveguide opening. It extends into waveguide 60 a sufficient amount to provide a secure connection of waveguide 60 to backplate 23 and lens 21.

The lens end of plug 80 fits through backplate 23 and into a port of lens 20 and may be any shape (such as the rectangular shape of FIG. 7 or the tapered shape of FIG. 8) that keys the plug securely into the port.

Plug 80 is an alternative to integrating a transition directly into lens 21 from waveguide 60. Making a separate plug transition offers several advantages. First, it mitigates the risk of having to rebuild the lens should an assembly error result in chipping off portions of the waveguide inserts. Also, plug 80 can act as field-replaceable units. Replacing a plug 80 is substantially cheaper and faster than reprinting a lens segment. Additionally, the modularity of plugs 80 allows the lens to be reused across multiple feeds. For example, one could switch from a feed assembly based on WRD350 to one based on WRD750 (7.5-18 GHZ), and it would only require printing a new set of plugs with the same lens-insert portion and a different waveguide-insert portion.

1. A feed assembly for a multibeam antenna having a gradiant-index (GRIN) lens, comprising:
a feed plate attached to the GRIN lens having a port for each channel of the antenna;
a waveguide associated with each recessed port, each waveguide having an opening for transmitting a signal into the GRIN lens;
a plug associated with each waveguide, each plug configured at a port end to fit into a port and configured at a waveguide end to fit into the associated waveguide; and
wherein the plug is made from the same material as the lens.

2. The feed assembly of claim 1, wherein the GRIN lens has a lattice pattern and the plug continues the lattice pattern.

3. The feed assembly of claim 1, wherein the port end of the plug provides a keyed fit into the lens.

4. The feed assembly of claim 1, wherein the waveguide end of the plug provides a keyed fit into the waveguide opening.

5. The feed assembly of claim 1, wherein the GRIN lens has a Luneburg configuration.

6. The feed assembly of claim 1, wherein the GRIN lens has a flat backside and the feed plate is a flat plate.

7. The feed assembly of claim 1, wherein the waveguide opening has ramped wedges on opposing sides.

8. The feed assembly of claim 7, wherein the waveguide end of the plug provides a keyed fit into the waveguide opening.
